(19) United States
(12) Patent Application Publication
(10) Pub. No.: US 2011/0225890 A1
(43) Pub. Date: Sep. 22, 2011

(54) GATE WITH FOOT-OPERATED LATCHING MECHANISM

(76) Inventors: Mark Greenwood, Arlington Hts., IL (US); Piet Schilt, Bergambacht (NL)

(21) Appl. No.: 12/726,152

(22) Filed: Mar. 17, 2010

(51) Int. Cl. E05C 1/10; E06B 3/36; E05C 19/16; E05B 65/06

(52) U.S. Cl. 49/394; 292/139; 292/251.5

(57) ABSTRACT

A gate for selectively restricting passage through a passageway includes a frame having a sill and first and second door jambs adapted for mounting within the passageway. A door is mounted by hinges to the first door jamb while a latch receptacle is mounted to the second door jamb. A pedal is movably mounted to the door as is a latch element. The latch element is slidable between an extended position, where the latch element engages the latch receptacle so that the door of the gate is locked in a closed position, and a retracted position, where the latch element is removed from the latch receptacle so that the door may be moved into an open position. A sliding linkage is connected between the pedal and the latch element so that the latch element is moved into the retracted position when the pedal is actuated. A magnet is positioned in the latch element and in the latch receptacle so as to pull the latch element into the extended position when the latch element is not engaged by the sliding linkage.

### FIELD OF THE INVENTION

The present invention relates generally to gates and, in particular, to a pet and child safety gate having a foot-operated latching mechanism.

### BACKGROUND

Gates that mount within doorways or between other opposing vertical surfaces that form passageways are popular safety products that enable a parent or pet owner to restrict child or pet access to rooms or areas of a home. Such rooms or areas may include, for example, breakable, valuable or potentially hazardous items or features such as stairways or balconies.

Such gates typically feature a generally U-shaped frame that is secured within a doorway or to other opposing vertical surfaces. A door is pivotally mounted by one side to one of the vertical door jambs of the frame. A latching mechanism secures the opposite side of the door to the other vertical door jamb of the frame. A lever is typically positioned on or near the top of the door and is lifted or otherwise manipulated to unlatch the door for opening. In some gate products, the user may also have to lift the door slightly to disengage the frame sill before swinging it open. Such gate products therefore require a user to use his or her hands to unlatch and at least partially open the door of the gate. This makes it difficult and inconvenient for the user to open the gate when his or her hands are full such as when carrying bags of groceries or other items or a child.

In view of the above difficulties, gates featuring pedal or foot-operated latching mechanisms have been developed. An example of such a gate is illustrated in U.S. Pat. No. 6,176,042 to Rossman et al. The Rossman et al. '042 patent discloses a pedal mounted on the frame of the gate. A user actuates the pedal to unlatch the gate and then may walk through the gate opening by simultaneously pushing the door of the gate open. The positioning of the pedal and associated components on the gate frame, however, requires widening one of the frame door jambs which narrows the width of the door and gate opening. Furthermore, the user must simultaneously push down on the pedal and at least slightly open the door of the gate in order to fully release it. This is an inconvenient and often difficult maneuver when a user's hands are

### BRIEF DESCRIPTION OF THE DRAWINGS

FIGS. 1A and 1B are perspective views of an embodiment of the gate of the invention with the door in a closed position and an open position, respectively;

FIG. 2 is an exploded view of the latching mechanism of the gate of FIGS. 1A and 1B;

FIG. 3 is an enlarged perspective view of the latch element and the bifurcated top portion of the sliding linkage of FIG. 2;

FIGS. 4A and 4B are enlarged partially broken away perspective views of the gate of FIGS. 1A and 1B showing the latching mechanism of FIGS. 2 and 3 in an assembled condition and illustrating the gate in locked and unlocked configurations, respectively;

FIGS. 5A and 5B are enlarged cross sectional views of the latch element, gooseneck spring and latch receptacle corresponding to FIGS. 4A and 4B, respectively;

FIGS. 6A and 6B are enlarged perspective views of the door closure magnets corresponding to FIGS. 1A and 1B, respectively.

### DETAILED DESCRIPTION OF EMBODIMENTS

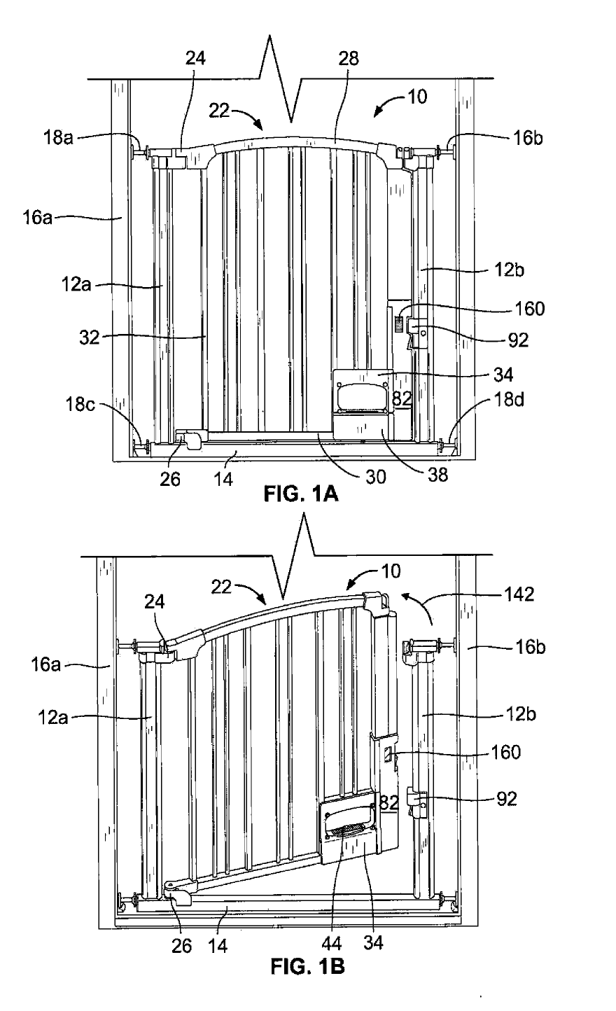

An embodiment of the gate of the present invention is indicated in general at 10 in FIGS. 1A and 1B. The gate 10 features a generally U-shaped frame consisting of a pair of vertical frame door jambs 12a and 12b joined at their bottom ends by a frame sill 14 so that a gate opening is defined. While the invention is described below in terms of an embodiment including a generally U-shaped frame, it is to be understood that the gate frame could instead feature a construction where the frame sill is eliminated and the door jambs are individually and independently mounted to supporting surfaces to define the gate opening. The frame is mounted between opposing surfaces 16a and 16b that define a passageway by threaded spindles 18a-18d having proximal ends that engage corresponding holes formed in the frame of the gate. Turning the spindles adjusts the degree by which they extend from the gate frame thus permitting a secure mounting between the opposing surfaces. The opposing surfaces 16a and 16b may be, for example, the inward-facing surfaces of a doorway, railings of a stairway, walls of a room or hallway or any other opposing vertical surfaces that define a passageway.

As further illustrated in FIGS. 1A and 1B, the gate includes a door, indicated in general at 22. The door is positioned within the gate opening and is pivotally mounted to frame door jamb 12a by upper hinge 24 and lower hinge 26. As a result, the door may pivot between a closed position, illustrated in FIG. 1A, and an open position, illustrated in FIG. 1B. The door features a top member 28, a bottom member 30 and a number of vertical members 32. A pedal 34 is mounted to the door and, as will be explained in greater detail below, may be actuated by the foot of a user to unlatch the gate.

The gate frame and door members are preferably constructed from steel tubing. For esthetic purposes, the door vertical members are preferably made of tubing having a round cross section, while the remaining tubing preferably features a square cross section. Other durable materials such as wood or appropriate plastics could be used instead of the steel tubing.

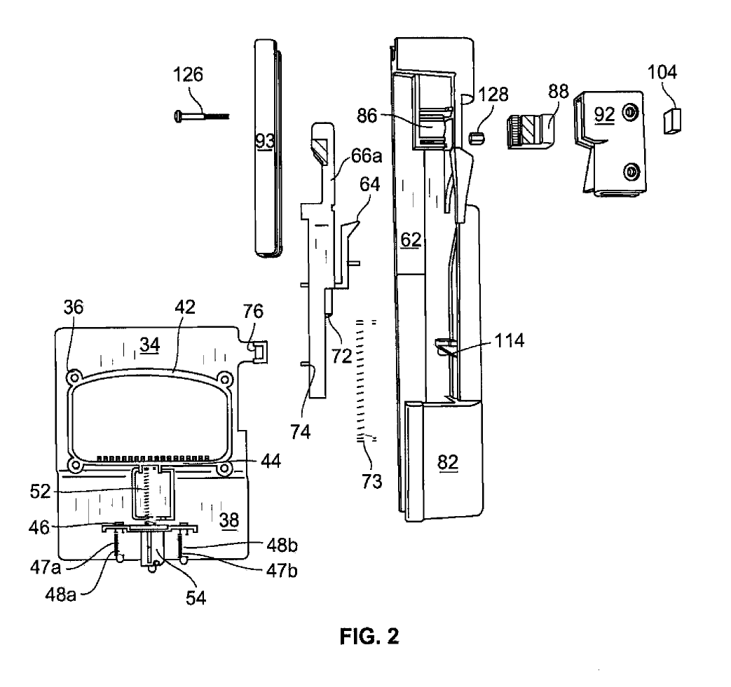

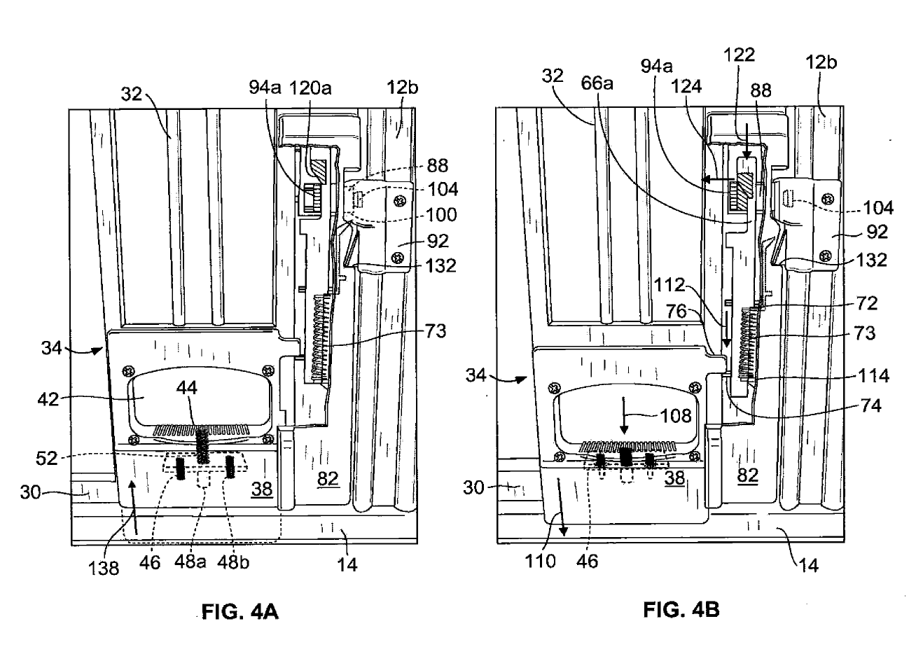

The gate of FIGS. 1A and 1B features a latching mechanism, the components of which are illustrated in an exploded view in FIG. 2. Pedal 34, which is preferably constructed from molded plastic, features two halves, one of which is illustrated in FIG. 2. The second half of the pedal 34, visible in FIGS. 1A, 1B, 4A and 4B, attaches to the half of FIG. 2 via screws that engage bosses 36 (FIG. 2). As indicated at 38 in FIGS. 1A and 2, the pedal includes a lower skirt portion 38 that receives the door bottom member 30. The pedal skirt portion also receives the frame sill 14 (FIGS. 1A and 1B) of the door when the pedal 34 is depressed, as described in greater detail below.

The pedal 34 includes a foot opening 42 having a bottom edge surface 44 (FIGS. 2 and 1B) that is generally flat and serrated for ease of actuation by the shoe of a user. As illustrated in FIGS. 2, 4A and 4B, a spring support plate 46 is positioned between the two pedal halves and is free to moved up and down with respect to the skirt 38 of the pedal. As illustrated in FIG. 2, the spring support plate is provided with downwardly-extending spring posts 47a and 47b which are surrounded by auxiliary compression coil springs 48a and 48b, respectively. A main compression coil spring 52 extends downwardly from the bottom edge 44 of the pedal opening and is received within a spring well 54 that is formed within the spring support plate 46. The bottom ends of the springs 48a and 48b engage the top surface of the bottom member 30 (FIG. 1A) of the gate door. Apertures corresponding to the spring posts 47a and 47b and the spring well 54 are formed in the top surface of gate door bottom member. The spring posts and well of the spring support plate pass through the corresponding apertures when the pedal is pushed down and the main and auxiliary springs are compressed.

The pedal spring arrangement of FIGS. 2, 4A and 4B may be replaced with a simple single compression coil spring arrangement, or any other spring arrangement for urging the pedal upwards into the position illustrated in FIGS. 1A, 1B and 4A. The spring(s) should be chosen so that an adult or older child may press down on the pedal with force that is significant to actuate it, but not a child. As an example only, such a force may be approximately forty pounds.

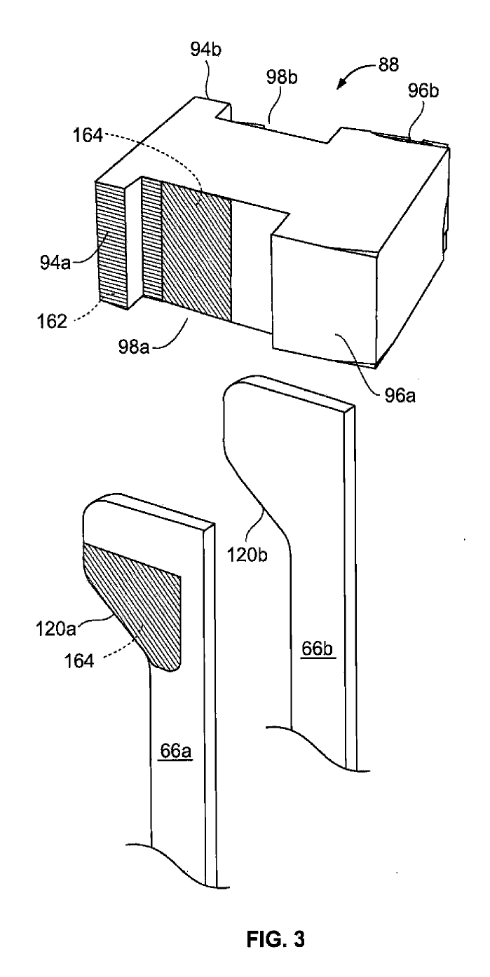

The gate latching mechanism also includes an elongated sliding linkage, indicated at 62 in FIG. 2. The linkage is provided with a gooseneck spring 64 and, as illustrated in FIGS. 2 and 3, a bifurcated top portion including arms 66a and 66b. With reference to FIG. 2, the linkage also is provided with a shoulder 72 and a push tab 74. As will be explained in greater detail below, shoulder 72 is engaged by a coil compression spring 73 while push tab 74 is removably engaged by knuckle 76 of the pedal 34.

The latching mechanism also includes a latch housing, indicated at 82 in FIG. 2, which includes a linkage passage 84 as well as a latch element support 86. The sliding linkage 62 is received within the linkage passage 84 while the latch element 88 is slidably positioned on latch element support 86. A latch receptacle 92 is also part of the latching mechanism. As illustrated in FIGS. 1A and 1B, the latch receptacle 92 is mounted upon one of the vertical frame door jams 12b of the gate frame so as oppose the latch element 88 of the door.

The pedal 34, spring support plate 46, linkage 62, latch housing 82, latch element 88, latch receptacle 92 and a latch housing cover 93 of FIG. 2 are all preferably constructed from molded plastic.

As illustrated in FIG. 3, the latch element 88 is generally I-shaped and features a proximal stepped portions 94a and 94b and distal stepped portions 96a and 96b. Recessed portions 98a and 98b are defined between the proximal and distal stepped portions. The arms 66a and 66b of the sliding linkage are sized and spaced so as to pass through the recessed portions 98a and 98b of the latch element when the latching mechanism is assembled.

The operation of the linkage mechanism will now be described with respect to FIGS. 3, 4A, 4B, 5A and 5B.

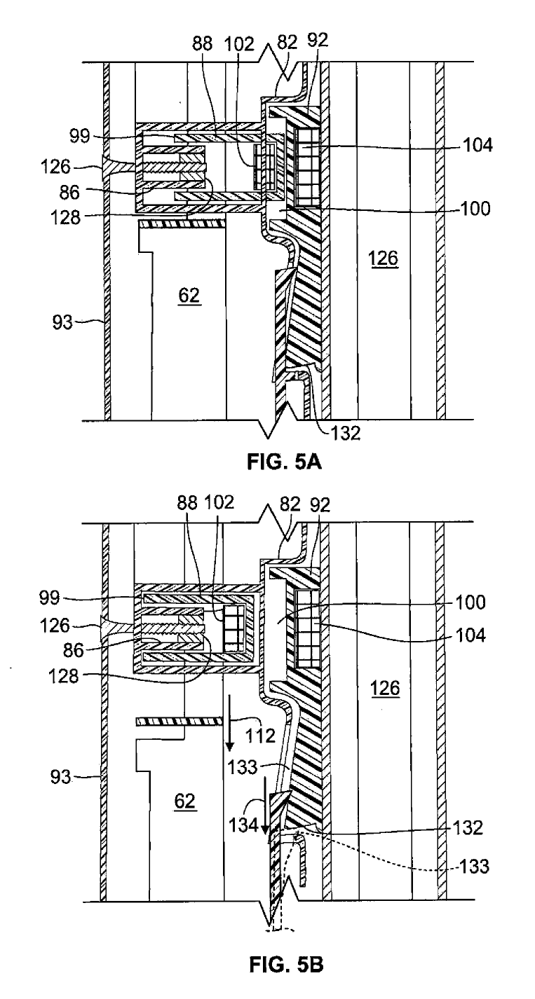

As illustrated in FIGS. 5A and 5B, the latch element 88 features an open proximal end 99 that receives the latch support 86 of the latch housing 82 in a telescopic fashion. As a result, the latch element 88 slides between an extended position, illustrated in FIGS. 4A and 5A, and a retracted position, illustrated in FIGS. 4B and 5B. As illustrated in FIGS. 4A, 5A and 5B, the latch receptacle 92, which is mounted upon vertical door jamb 12b of the gate frame, features a latch socket 100. As illustrated in FIGS. 4A and 5A, the latch socket 100 is engaged by the distal end of the latch element 88 when the latch element is in the extended position. This corresponds to the locked configuration of the gate where the door of the gate cannot be opened by a child, pet or the like. When the distal end of the latch element 88 is in the retracted position, illustrated in FIGS. 4B and 5B, the gate is in the unlocked configuration so that the door may be opened.

As illustrated in FIGS. 5A and 5B, the distal portion of the latch element (which corresponds to distal step portions 96a an 96b in FIG. 3), contains a magnet 102. As illustrated in FIGS. 4A, 4B, 5A and 5B, the latch receptacle 92 also includes a magnet 104. Magnet 104 attracts magnet 102. As a result, the attraction between magnets 102 and 104 secures the latch element 88 in the extended position illustrated in FIGS. 4A and 5A, and thus the gate, in the locked configuration until the latching mechanism is actuated by the pedal as will now be described. A piece of metal could be substituted for magnet 104, in which case magnet 102 would still be attracted to the piece of metal and pull the latch element into the extended position. Alternatively, a piece of metal could be substituted for magnet 102, in which case magnet 104 would still be attracted to the piece of metal and pull the latch element into the extended position.

When a user wishes to walk through the opening of the gate, with reference to FIGS. 4A and 4B, he or she uses a foot to press down on the bottom edge surface 44 of opening 42 of the pedal 34, as indicated by arrow 108 in FIG. 4B. When the user does so, coil springs 48a, 48b and 52 are compressed, and the pedal travels downward, as indicated by arrow 110 in FIG. 4B. Downward travel of the pedal causes the skirt 38 of the pedal to engage frame sill 14, which prevents the door, and thus the pedal, from moving horizontally while the user's foot is still on the pedal when the gate becomes unlocked. As illustrated in FIG. 4B, as the pedal travels downward, the knuckle 76 of the pedal pushes the push tab 74 of the sliding linkage 62, and thus the sliding linkage itself, downward, as indicated by arrow 112 (see also FIG. 5B). This is against the upward urging of compression coil spring 73, which has a top end that engages the shoulder 72 of the sliding linkage, and a bottom end that engages a spring tab (114 in FIGS. 4B and 2) near the bottom of linkage passage of the latch housing.

As the sliding linkage 62 travels downwards, so does the bifurcated portion including arms 66a and 66b. As illustrated in FIGS. 3, 4A and 4B, the arms each feature a camming surface, indicated at 120a and 120b. With reference to FIG. 4B, as the arm 66a of the sliding linkage moves down, as indicated by arrow 122, the camming surface 120a (FIGS. 3 and 4A) engage the proximal step portion 94a of the latch element 88 (see also FIG. 3). Camming surface 120b of FIG. 3 similarly engages proximal step portion 94b. This causes the latch element 88 to travel in the direction of arrow 124 in FIG. 4B so that the latch element is retracted into the latch housing 82. Step portions 94a and 94b are preferably slightly tapered from bottom to top (being slightly wider at the bottom) to better match the profiles of the camming surfaces 120a and 120b for smoother depression of the pedal.

As described previously, the sliding linkage is provided with a gooseneck spring 64 (FIGS. 2, 4A, 4B, 5A and 5B). The spring is shaped to urge a tip 133 of the spring away from the sliding linkage 62. As illustrated at 132 in FIGS. 2, 4A, 413, 5A and 5B, the latch receptacle 92 is provided with a locking projection 132. With reference to FIG. 5B, as the sliding linkage moves down, the gooseneck spring 64 also moves down, as illustrated by arrow 134. When the pedal is fully depressed, as illustrated in phantom in FIG. 4A, the tip 133 of the gooseneck spring 64 engages the bottom of the locking projection 132 of the latch receptacle, as illustrated in phantom in FIG. 5B. The pedal is then free to travel back upwards, as indicated by arrow 138 in FIG. 4A, when the user removes his or her foot from the pedal, while the sliding linkage remains at its lower-most position with its camming surfaces securing the latch element in the fully retracted position.

With the gate now in the unlocked configuration, the user may push the door open, as illustrated by arrow 142 in FIG. 1B using, for example, his or her knee or shin, and walk through the gate opening. As the gate door is opened, the gooseneck spring tip 133 (FIG. 5A) is forced out from underneath the locking projection 132 of the latch receptacle 92. This causes the sliding linkage 62 to move upwards, back into the position illustrated in FIG. 4A, due to the urging of compression coil spring 73.

As illustrated in FIGS. 5A and 5B, the latch housing cover 93 (see also FIG. 2) is secured to the latch housing 82 by a threaded screw 126 that engages a nut 128. Both the screw and nut are made of metal. As a result, the magnet 102 of the latch element 88 secures the latch element into the retracted position due to the attraction of the magnet 102 to the nut 128, even though the camming surfaces of the sliding linkage are no longer engaging the proximal stepped portions of the latch element. Any other metallic piece could be substituted for the nut 128 in the latch housing. In addition, it should be noted that a piece of metal could be substituted for magnet 102 if a magnet replaced the nut 128, or was otherwise present in the latch housing.

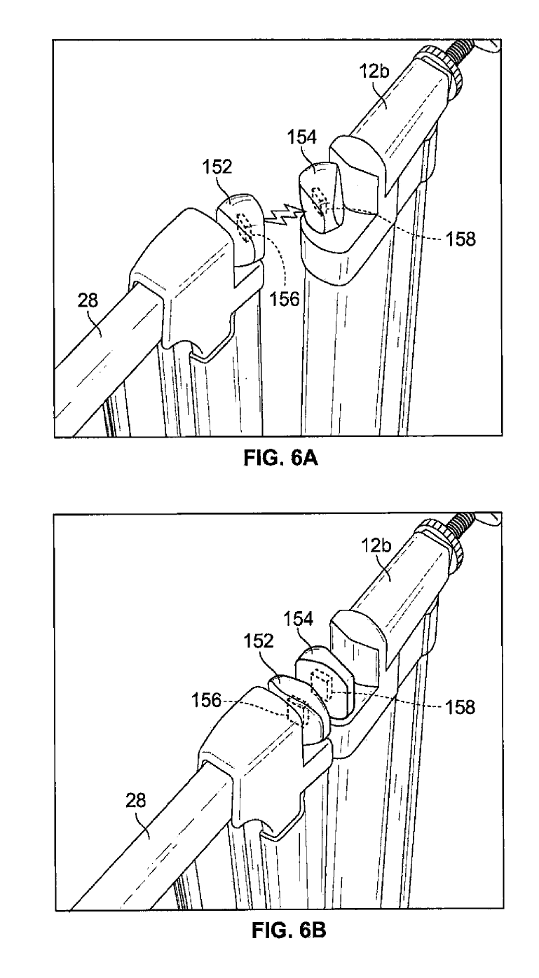

As illustrated in FIGS. 6A and 6B, the distal end of the door top member 28 and the top of the vertical frame door jamb 12b is provided with pivotally mounted magnet housings 152 and 154, respectively. Magnet housing 152 contains closure magnet 156 while magnet housing 154 contains closure magnet 158 (both closure magnets indicated in phantom). As indicated in FIG. 6A, the closure magnets have a strong attraction for one another. As a result, when the door of the gate is in an open position such as the one illustrated in FIG. 1B, the attraction of the closure magnets pulls the door into the closed position illustrated in FIGS. 1A and 6B. With reference to FIG. 5B, at this point, the magnet 102 of the latch element 88 is opposing the magnet 104 of the latch receptacle 92. This attraction is stronger than the attraction between the latch element magnet 102 and the nut 128 of the latch housing. As a result, as illustrated in FIG. 5A, the latch element is pulled into the socket 100 of the latch receptacle so that the gate is once again placed in the locked configuration.

As illustrated in FIGS. 1A and 1B, the gate also provides a status indicator in the form of an indicator window 160. A similar indicator window (not shown) is provided in the opposite side of the latch housing. As indicated in phantom at 162 of FIG. 3, the proximal stepped portions 94a and 94b, and small sections of the recessed portions 98a and 98b, are painted or otherwise colored red. As indicated at 164 in FIG. 3, larger sections of the recessed portions 98a and 98b and portions of the arms 66a and 66b of the sliding linkage adjacent to camming surfaces 120a and 120b are painted or otherwise colored green. When the latch element is in the extended position illustrated in FIGS. 4A and 5A, the red-colored portions 162 (FIG. 3) of the latching element appear in the windows 160 (FIGS. 1A and 1B) of the latch housing indicating that the gate is in the locked configuration. When the pedal is pressed down, and the arms and camming surfaces move downwards, and the latch element retracts, as indicated in FIGS. 4B and 5B, the green portions 164 (FIG. 3) of the latching element and sliding linkage arms appear in the windows 160 (FIGS. 1A and 1B) of the latch housing indicating that the gate is in the unlocked configuration. Given that the green color is on both the latching element and the sliding linkage arms, the green color remains visible in the windows both when the sliding linkage is locked in its lower-most position by the tip of the gooseneck spring 133 engaging the locking projection 132 of the latch receptacle and when the latch element is secured in the fully retracted position by the interaction of the magnet 102 with the nut 128 (FIG. 5B).

In view of the above, the gate of FIGS. 1-6B provides a secure barrier between rooms or spaces that may be safely and easily opened by an adult, older child or pet owner to permit passage without the use of the operator's hands. The gate also provides automatic door closure and locking as well as an indicator showing a user at a glance the configuration of the gate latching mechanism (locked or unlocked).

While the preferred embodiments of the invention have been shown and described, it will be apparent to those skilled in the art that changes and modifications may be made therein without departing from the spirit of the invention, the scope of which is defined by the appended claims.

What is claimed is:

1. A gate for selectively restricting passage through a passageway comprising:
a) a frame including first and second door jambs adapted for mounting within the passageway;
b) a door mounted by hinges to the first door jamb;
c) a latch receptacle mounted to the second door jamb;
d) a pedal movably mounted on the door;
e) a latch element positioned on the door and slidable between an extended position where the latch element engages the latch receptacle so that the door of the gate is locked in a closed position, and a retracted position where the latch element is removed from the latch receptacle so that the door may be moved into an open position;
f) a sliding linkage connected between the pedal and the latch element so that the latch element is engaged and moved into the retracted position by the sliding linkage when the pedal is actuated; and
g) a magnet positioned on the gate so as to pull the latch element into the extended position when the latch element is not engaged by the sliding linkage.

2. The gate of claim 1 wherein the frame includes a sill attached between bottom ends of the first and second door frames.

3. The gate of claim 1 wherein the sliding linkage slides downward when a bottom portion of the sliding linkage is engaged by the pedal and a top portion of the sliding linkage is provided with a camming surface that engages the latching element so as to move the latching element in the retracted position when the sliding linkage slides downward.

4. The gate of claim 3 wherein the latch element includes a proximal stepped portion that is engaged by the camming surface of the sliding linkage.

5. The gate of claim 3 further comprising a sliding linkage spring urging the sliding linkage upwards.

6. The gate of claim 5 wherein the latch receptacle includes a locking projection and further comprising a gooseneck spring attached to the sliding linkage, said gooseneck spring having a tip that engages the locking projection when the sliding linkage slides downward when engaged by the pedal so as to lock the sliding linkage in a lowered position, said tip of the gooseneck spring disengaging the locking projection of the latch receptacle when the gate is opened so that the sliding linkage is released from the lowered position.

7. The gate of claim 1 wherein the sliding linkage engages the latch element to move it into the retracted position when the pedal is depressed, and the gate further comprising a spring urging the pedal away from the depressed position.

8. The gate of claim 1 wherein the magnet includes a first magnet positioned in a distal end of the latch element and further comprising a second magnet positioned within the latch receptacle, said first and second magnets attracting one another so as to pull the latch element into engagement with the latch receptacle.

9. The gate of claim 8 further comprising a metallic piece positioned on the door adjacent to the proximal end of the latch element, said metallic piece attracting the first magnet when the door is open to secure the latch element in the retracted position.

10. The gate of claim 1 further comprising a first closure magnet positioned on the door and a second closure magnet positioned on the second door jamb, said first and second closure magnets attracting one another so as to pull the gate door from an open position to a closed position.

11. The gate of claim 1 further comprising a latch housing mounted on the door and within which the sliding linkage is positioned, said latch housing including an indicator window and said latch element including a first colored portion and a second colored portion, said first colored portion showing through the indicator window when the latch element is in the extended position to indicate a locked configuration of the gate, said second colored portion showing through the indicator window when the latch element is in the retracted position to indicate an unlocked configuration of the gate.

12. The gate of claim 1 further comprising a latch housing mounted on the door and within which the latch element and sliding linkage are positioned, said latch housing including an indicator window and said latch element including a first colored portion and said sliding linkage including a second colored portion, said first colored portion showing through the indicator window when the latch element is in the extended position to indicate a locked configuration of the gate, said second colored portion showing through the indicator window when the latch element is in the retracted position due to engagement by the sliding linkage to indicate an unlocked configuration of the gate.

13. A gate for selectively restricting passage through a passageway comprising:
a) a frame including first and second door jambs, said frame adapted for mounting within the passageway;
b) a door mounted by hinges to the first door jamb;
c) a latch receptacle mounted to the second door jamb;
d) a pedal movably mounted on the door;
e) a latch element positioned on the door and slidable between an extended position where the latch element engages the latch receptacle so that the door of the gate is locked in a closed position, and a retracted position where the latch element is removed from the latch receptacle so that the door may be moved into an open position;
a sliding linkage connected between the pedal and the latch element so that the latch element is engaged and moved into the retracted position by the sliding linkage when the pedal is actuated; and
g) means for magnetically pulling the latch element into the extended position when the latch element is not engaged by the sliding linkage.

14. The gate of claim 13 wherein the frame includes a sill attached between bottom ends of the first and second door frames.

15. The gate of claim 13 wherein the sliding linkage slides downward when a bottom portion of the sliding linkage is engaged by the pedal and a top portion of the sliding linkage is provided with a camming surface that engages the latching element so as to move the latching element in the retracted position when the sliding linkage slides downward.

16. The gate of claim 15 wherein the latch element includes a proximal stepped portion that is engaged by the camming surface of the sliding linkage.

17. The gate of claim 15 further comprising a sliding linkage spring urging the sliding linkage upwards.

18. The gate of claim 17 wherein the latch receptacle includes a locking projection and further comprising a gooseneck spring attached to the sliding linkage, said gooseneck spring having a tip that engages the locking projection when the sliding linkage slides downward when engaged by the pedal so as to lock the sliding linkage in a lowered position, said tip of the gooseneck spring disengaging the locking projection of the latch receptacle when the gate is opened so that the sliding linkage is released from the lowered position.

19. The gate of claim 13 wherein the sliding linkage engages the latch element to move it into the retracted position when the pedal is depressed, and the gate further comprising a spring urging the pedal away from the depressed position.

20. The gate of claim 13 wherein the means for magnetically pulling includes a first magnet positioned in a distal end of the latch element and further comprising a second magnet positioned within the latch receptacle, said first and second magnets attracting one another so as to pull the latch element into engagement with the latch receptacle.

21. The gate of claim 20 further comprising a metallic piece positioned on the door adjacent to the proximal end of the latch element, said metallic piece attracting the first magnet when the door is open to secure the latch element in the retracted position.

22. The gate of claim 13 further comprising a first closure magnet positioned on the door and a second closure magnet positioned on the second door jamb, said first and second closure magnets attracting one another so as to pull the gate door from an open position to a closed position.

23. The gate of claim 13 further comprising a latch housing mounted on the door and within which the sliding linkage is positioned, said latch housing including an indicator window and said latch element including a first colored portion and a second colored portion, said first colored portion showing through the indicator window when the latch element is in the extended position to indicate a locked configuration of the gate, said second colored portion showing through the indicator window when the latch element is in the retracted position to indicate an unlocked configuration of the gate.

24. The gate of claim 13 further comprising a latch housing mounted on the door and within which the latch element and sliding linkage are positioned, said latch housing including an indicator window and said latch element including a first colored portion and said sliding linkage including a second colored portion, said first colored portion showing through the indicator window when the latch element is in the extended position to indicate a locked configuration of the gate, said second colored portion showing through the indicator window when the latch element is in the retracted position due to engagement by the sliding linkage to indicate an unlocked configuration of the gate.
